(19) United States
(12) Patent Application Publication
(10) Pub. No.: US 2024/0388355 A1
(43) Pub. Date: Nov. 21, 2024

(54) SMART INTEGRATED ACCESS BACKHAUL THAT SUPPORTS REPEATER MODE

(71) Applicant: Nokia Technologies Oy, Espoo (FI)

(72) Inventors: Roy YANG, Buffalo Grove, IL (US); Axel MUELLER, Paris (FR); Kevin WANUGA, Souderton, PA (US)

(21) Appl. No.: 18/694,021

(22) PCT Filed: Sep. 29, 2021
(86) PCT No.: PCT/US2021/071637

§ 371 Date: Mar. 21, 2024

(51) Int. Cl. H04B 7/155

(52) U.S. Cl. CPC H04B 7/15542; H04B 7/15557

(57) ABSTRACT

Techniques of relaying signals include modifying an IAB node to have a built-in mode to support signal repetition, wherein a portion of the time-frequency resources of the IAB are dynamically allocated in the repeater mode for delay-sensitive data.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's LTE upgrade path for mobile networks. In LTE, base stations or access points (APs), which are referred to as enhanced Node AP (eNBs), provide wireless access within a coverage area or cell. In LTE, mobile devices, or mobile stations are referred to as user equipment (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, e.g., above 6 GHz. For fifth generation wireless systems (5G), an access architecture for deployment of cellular radio equipment employing mmWave radio spectrum has been proposed. Other example spectrums may also be used, such as cmWave radio spectrum (e.g., 3-30 GHz).

### SUMMARY

According to an example implementation, a method includes configuring, by a donor node in a network, an integrated access backhaul node within the network as supporting a non-regenerative relay mode and a regenerative relay mode, the non-regenerative mode being activated in response to a request to forward signal data that includes delay-sensitive data, the regenerative relay mode being activated in response to a request to forward signal data that does not include delay-sensitive data.

According to an example implementation, an apparatus includes at least one processor and at least one memory including computer program code, the at least one memory and the computer program code configured to, with the at least one processor, cause the apparatus at least to configure, by a donor node in a network, an integrated access backhaul node within the network as supporting a non-regenerative relay mode and a regenerative relay mode, the non-regenerative mode being activated in response to a request to forward signal data that includes delay-sensitive data, the regenerative relay mode being activated in response to a request to forward signal data that does not include delay-sensitive data.

According to an example implementation, an apparatus includes means for configuring, by a donor node in a network, an integrated access backhaul node within the network as supporting a non-regenerative relay mode and a regenerative relay mode, the non-regenerative mode being activated in response to a request to forward signal data that includes delay-sensitive data, the regenerative relay mode being activated in response to a request to forward signal data that does not include delay-sensitive data.

According to an example implementation, a computer program product includes a computer-readable storage medium and storing executable code that, when executed by at least one data processing apparatus, is configured to cause the at least one data processing apparatus to configure, by a donor node in a network, an integrated access backhaul node within the network as supporting a non-regenerative relay mode and a regenerative relay mode, the non-regenerative mode being activated in response to a request to forward signal data that includes delay-sensitive data, the regenerative relay mode being activated in response to a request to forward signal data that does not include delay-sensitive data.

According to an example implementation, a method includes transmitting, by a repeater of an integrated access backhaul node that also includes a mobile terminal and a distributed unit to a donor node, the repeater configured to perform a non-regenerative relay operation on a received signal that includes delay-sensitive data, the mobile terminal and distributed unit both configured to perform a regenerative relay operation on a received signal, capability data representing a capability of the integrated access backhaul node to support the non-regenerative relay operation, the capability data including an indication of whether the integrated access backhaul node supports the non-regenerative relay operation, a resource identifier identifying time-frequency resources allocated to the repeater, and a repeat delay indicator indicating an internal delay of the repeater.

According to an example implementation, an apparatus includes at least one processor and at least one memory including computer program code, the at least one memory and the computer program code configured to, with the at least one processor, causes the apparatus at least to transmit, by a repeater of an integrated access backhaul node that also includes a mobile terminal and a distributed unit to a donor node, the repeater configured to perform a non-regenerative relay operation on a received signal that includes delay-sensitive data, the mobile terminal and distributed unit both configured to perform a regenerative relay operation on a received signal, capability data representing a capability of the integrated access backhaul node to support the non-regenerative relay operation, the capability data including an indication of whether the integrated access backhaul node supports the non-regenerative relay operation, a resource identifier identifying time-frequency resources allocated to the repeater, and a repeat delay indicator indicating an internal delay of the repeater.

According to an example implementation, an apparatus includes means for transmitting, by a repeater of an integrated access backhaul node that also includes a mobile terminal and a distributed unit to a donor node, the repeater configured to perform a non-regenerative relay operation on a received signal that includes delay-sensitive data, the mobile terminal and distributed unit both configured to perform a regenerative relay operation on a received signal, capability data representing a capability of the integrated access backhaul node to support the non-regenerative relay operation, the capability data including an indication of whether the integrated access backhaul node supports the non-regenerative relay operation, a resource identifier identifying time-frequency resources allocated to the repeater, and a repeat delay indicator indicating an internal delay of the repeater.

According to an example implementation, a computer program product includes a computer-readable storage medium and storing executable code that, when executed by at least one data processing apparatus, is configured to cause the at least one data processing apparatus to transmit, by a repeater of an integrated access backhaul node that also includes a mobile terminal and a distributed unit to a donor node, the repeater configured to perform a non-regenerative relay operation on a received signal that includes delay-sensitive data, the mobile terminal and distributed unit both configured to perform a regenerative relay operation on a received signal, capability data representing a capability of the integrated access backhaul node to support the non-regenerative relay operation, the capability data including an indication of whether the integrated access backhaul node supports the non-regenerative relay operation, a resource identifier identifying time-frequency resources allocated to the repeater, and a repeat delay indicator indicating an internal delay of the repeater.

In some implementations, the device is configured to operate as a regenerative and non-regenerative device simultaneously.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a digital communications network according to an example implementation.

FIG. 2 is a diagram illustrating a smart IAB node that supports a repeater mode according to an example implementation.

FIG. 3 is a diagram illustrating a division of time-frequency resources between a MT, a DU, and a RF repeater of a smart IAB node, according to an example implementation.

FIG. 4 is a diagram illustrating a time-division duplex constraints on repeating resources in non-full duplex and non-independent spatial division multiplex IAB nodes according to an example implementation.

FIG. 5 is a timing diagram illustrating a one-hop transmission with both IAB and repeater operation according to an example implementation.

FIG. 6 is a diagram illustrating a repeating resource grid surrounded by a guard band of resource elements, according to an example implementation.

FIG. 7 is a diagram illustrating two options for using an RF repeat mode in a two-hop smart IAB network to bypass certain nodes in a backhaul adaptation protocol, according to an example implementation.

FIG. 8 is a diagram illustrating a user plane protocol stack architecture for the two options, according to an example implementation.

FIG. 9 is a sequence diagram illustrating a signaling flow to bypass both IAB nodes 1 and 2, according to an example implementation.

FIG. 10 is a sequence diagram illustrating a signaling flow to bypass IAB node 1, according to an example implementation.

FIG. 11 is a flow chart illustrating a process of configuring a smart IAB node according to an example implementation.

FIG. 12 is a flow chart illustrating a process of configuring a smart IAB node according to an example implementation.

FIG. 13 is a block diagram of a node or wireless station (e.g., base station/access point, relay node, or mobile station/user device) according to an example implementation.

### DETAILED DESCRIPTION

The principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

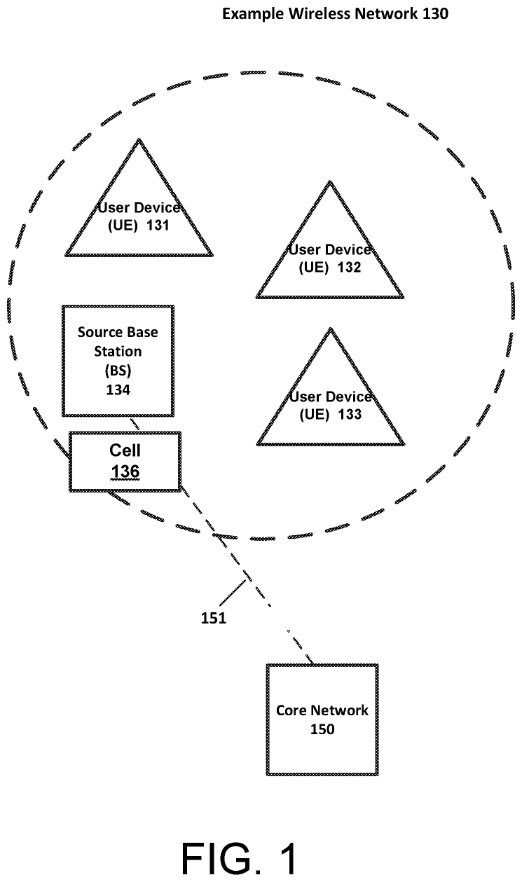

FIG. 1 is a block diagram of a digital communications system such as a wireless network 130 according to an example implementation. In the wireless network 130 of FIG. 1, user devices 131, 132, and 133, which may also be referred to as mobile stations (MSs) or user equipment (UEs), may be connected (and in communication) with a base station (BS) 134, which may also be referred to as an access point (AP), an enhanced Node B (eNB), a gNB (which may be a 5G base station) or a network node. At least part of the functionalities of an access point (AP), base station (BS) or (e) Node B (eNB) may be also be carried out by any node, server or host which may be operably coupled to a transceiver, such as a remote radio head. BS (or AP) 134 provides wireless coverage within a cell 136, including the user devices 131, 132 and 133. Although only three user devices are shown as being connected or attached to BS 134, any number of user devices may be provided. BS 134 is also connected to a core network 150 via an interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/serving cell change of user devices between BSs, one or more gateways that may forward data and control signals between the BSs and packet data networks or the Internet, and other control functions or blocks.

The various example implementations may be applied to a wide variety of wireless technologies, wireless networks, such as LTE, LTE-A, 5G (New Radio, or NR), cmWave, and/or mmWave band networks, or any other wireless network or use case. LTE, 5G, cmWave and mmWave band networks are provided only as illustrative examples, and the various example implementations may be applied to any wireless technology/wireless network. The various example implementations may also be applied to a variety of different applications, services or use cases, such as, for example, ultra-reliability low latency communications (URLLC), Internet of Things (IoT), time-sensitive communications (TSC), enhanced mobile broadband (eMBB), massive machine type communications (MMTC), vehicle-to-vehicle (V2V), vehicle-to-device, etc. Each of these use cases, or types of UEs, may have its own set of requirements.

A common problem in cellular radio deployment is the presence of coverage holes. Be it due to shadowing, outside-to-inside losses, interference, or manifold other reasons, operators struggle with “holes” in their network coverage. Traditionally (in 4G and before), so called “RF repeaters/amplify-and-forward relays” were used to patch such holes and carry coverage inside well shielded buildings.

In 5G NR Rel-16, a new method was introduced called “Integrated Access Backhaul” (IAB), which constitutes a “regenerative/decode-and-forward relay.” Both technologies can be used to alleviate coverage holes, but both have their distinct advantages and disadvantages, which will be compared in the following.

Integrated Access Backhaul (IAB) node leverages the spectral efficiencies of New Radio and the increased capacity afforded by the higher bands available in 5G to deliver an alternative solution to optical cell site backhaul. It can be employed as a short-term alternative to fiber or as a permanent option for areas with poor coverage or those without right of way access. IAB allows for multi-hop backhauling using the same frequencies employed for user equipment (UE).

Cellular repeaters are widely used in the 2G/3G/4G wireless networks to provide coverage extension. A RF repeater receives the signal from the nearby base station, amplifies and retransmits it to the nearby user equipment in the downlink direction, and in the uplink direction, the RF repeater receives signals from the user equipment, amplifies and retransmits to the base station.

A repeater can be used in 5GNR as well for coverage improvement.
5GNR RF repeaters are currently being standardized in 3GPP.
   NR repeater is a new 3GPP Work Item for Release 17 (RAN4) and Release 18 (RAN1 to 4).
   TS 38.106 is dedicated to the NR repeater specification, which is an extension of TS 36.106 (LTE Repeater).

For coverage improvement/extension for area without fiber access, both IAB and Repeater nodes can be used, with each having their own advantage and disadvantages.
NR IAB is highly spectrally efficient but introduces additional delay, as IAB is a “regenerative relay”.
RF repeaters are non-regenerative and thus introduce minimal latency, but they reduce spectral efficiency in the whole cell by actively amplifying signal and noise. They are also a non-negligible source of “longer than expected distance” interference (echo).
A repeater has significant cost advantage over an IAB device. A repeater has less energy consumption, smaller form factor and less weight for easier deployment.

There is significant interest in the area of serially combined usage of IAB nodes and the repeater nodes.

The 5G NR standard is prepared to handle traffic from the three big groups: eMBB, URLLC, mMTC. Different types of traffic can be identified by the Quality of service (QOS) identifiers, which map the corresponding data on the QoS flows.

QOS flows can be mapped to different data radio bearers (DRBs), which are linked to the physical resources and channels on the air-interface used to transport the symbols. QoS flows for URLLC traffic might be mapped to physical channels and resources that offer reduced delay, when compared to eMMB (“high throughput”) traffic.

Conventional IAB and repeaters are both used to fill coverage holes or to extend the range with wireless backhauling.

Due to the regenerative nature, the IAB node may be sub-optimal to handle delay-sensitive data as it introduces latency that may not be acceptable.
IAB node is a relay and it really is oblivious to the content of the data traffic. To demodulate/decode and re-encode/re-modulate Data Radio Bearers (DRB) may be wasteful, especially for delay sensitive data.
   The original reason for the IAB node to be regenerative are two folds: a). To take advantage of the different SNR between access and backhaul link, b). To potentially map several DRBs into the one BAP channel (N:1 mapping).
   For URLLC, a). The SNR issue can be addressed (URLLC uses highly conservative MCS values to achieve high reliability so may not be SNR sensitive) b). It is highly likely that the URLLC traffic uses dedicated BAP channel (1:1 mapping), rather than aggregate with other traffic into one BAP channel (N:1 mapping) which results in extra latency.
The following are factors that contribute to the additional latency in IAB from a gNB:
   Physical layer handling: decode and re-encode the data, per hop HARQ (i.e., introduce jitter on top of latency), etc.
   MAC layer handling: separate time slots for access the backhaul. BAP protocol handling.
   Existing latency reduction solution like the mini-slot, may not work well (mini-slot needs to be decoded and then regenerated for a new mini slot by the IAB before reaching the UE).
   Multi-hop IAB nodes can multiply the latency problem at least N times (N is the number of hops).
      Additional jitter is introduced due to per hop HARQ induced uncertainty.
One example of delay-sensitive data is URLLC, which was introduced in Rel15 and is being enhanced in Rel16 (eURLLC) and beyond. URLLC/eURLLC is delay-sensitive.
   eURLLC is a key enabler for enhanced AR/VR, factory automation, autonomous driving, automated train, advanced UAV (Unmanned Aerial Vehicle), electrical power distribution, etc.
   eURLLC requires very low latency (<1 ms E2E network) and low jittering (<=0.25 ms). These are tough requirements for the current gNB even without the IAB node/multi-hop IAB node between the donor and the UE.
Another example of delay-sensitive data could be 5G Multi-cast Broadcast Service (MBS).
   In Rel17 NR, 3GPP has approved a work item RP-193248 for support of MBS, which is currently 45% completed [RP-211361]. 3GPP has studied (TR 36.890) the use of HARQ for improving the reliability of Point to Multi-Point (PTM) radio transmissions. The general idea is that a common UL physical resource (e.g. PUCCH or PRACH) is announced to all the UEs, and the UE who is not able to decode the MBS payload shall send a “NACK” signal over the common resource, the MBS system can based on the aggregated “NACK” energy to determining how many UEs are not able to receive the MBS and adjust the MCS accordingly.
   HARQ for multi-cast traffic will not work for IAB nodes. Due to regeneration, the MBS traffic cannot be sent to the UEs served by the IAB in the same time slot as the UEs served by the donor gNB. As a result, the HARQ results (from MT in IAB to gNB vs. from UE to gNB) will be off as well. (The problem is even worse in multi-hop IABs.)
   This could result in in-accurate information for MBS feedback loop.

There is a need to address the latency issue for time and/or delay sensitive data in IAB node without compromising on the spectral efficiency more than absolutely necessary.

Repeaters also have shortcomings. While repeaters do not increase latency very much, they have their own set of issues:
“Single box” repeaters have limits on how much the signal can be amplified, due to feedback (or isolation) between the Tx and Rx side.
Repeater reduce spectral efficiency in the whole cell by actively amplifying signal and noise.
They are also a non-negligible source of intra- and inter-cell interference.
Finally, the signal quality, i.e., SNR, is reduced by passing through repeater(s). Accordingly, high MCS/TPUT is limited in repeater networks.

In contrast to the above-described conventional IAB and repeaters, improved techniques of relaying signals include modifying an IAB node to have a built-in mode to support signal repetition, wherein a portion of the time-frequency resources of the IAB are dynamically allocated in the repeater mode for delay-sensitive data.

The improved technique provides several advantages:
Smart IAB with the repeater mode allows a RF passthrough option to transmit delay-sensitive data, such as URLLC/eURLLC, and MBS.
   With repeater mode, URLLC/eURLLC can experience minimal latency along the multi-hop IAB devices in order to meet the enhanced latency requirement. (<1 ms end to end).
   MBS traffic will be correctly acknowledged in time by UEs served by the donor as well as UEs served by the IAB. More accurate feedback allows more reliable MBS transmission across 5G networks with mixed deployment of gNB and IAB nodes.
Smart IAB leverages the advantage of both existing IAB solution (better spectral efficiency) and the repeater solution (low latency). In fact, it offers maximal flexibility to switch between the two modes.
   The size and the occasion of the time-frequency resources for signal repetition can be configured through signaling.
      It can operate in a full IAB mode, full repeater mode (though not recommended) or anywhere in between.
   The user traffic (Data Radio Bearers) that is to be repeated is configurable. For example, the SDAP (Service Data Adaptation Protocol) function can map a QoS flow to a data radio bearer which can be further mapped to the time-frequency resources to be repeated.
      It can repeat on “as needed” basis. A better solution than a standalone repeater.
Smart IAB is compatible with the massive MIMO capability of the existing IAB node.
   The incoming signal from multiple antenna elements can go through a Rx beamformer in the direction of the transmit entity to get the best BF gain to form the beamformed Rx signal.
   The beamformed Rx signal can immediately go through a Tx beamformer such that the weights applied to the multiple antenna elements will point the composite Tx signal in the direction of the receiving entity.
   The spatial direction of the UE may be already known to the IAB through non-repeater mode. In a way, the repeater mode can be applied to the delay sensitive data immediately without latency.
   In contrast, a standalone repeater will require some complicated measurement and signaling (i.e. somehow pass the access measurement back to the donor gNB) to be “smart”.
Capacity boost
   With some of time-frequency resources reserved for repeater mode, the processing capability (L1, L2, L3) is saved to improve performance. For example, resolve computing bottle necks, increase the number of connected, inactive or idle users that the IAB can serve, deploy more advanced algorithms, etc.

The improved technique provides a method and a system for the Integrated Access and Backhaul (IAB) node to have a built-in mode to support signal repetition, wherein a portion of the time-frequency resources of the IAB can be dynamically allocated in the repeater mode for time-sensitive data. Additionally, the improved technique also provides the required control signalling between the donor gNB and the smart IAB node to allow such system to be used in 5G NR networks.

Some definitions that are used herein follow. An integrated access backhaul node (IAB) allows for multi-hop wireless backhauling using the same frequencies employed for user equipment (UE) access or a distinct, dedicated, frequency. A donor node has wired connection to the core network and it terminates the wireless backhaul traffic of the IAB node. A regenerative relay mode includes a smart IAB node performing a decoding and subsequent re-encoding on a signal prior to amplification for spectral efficiency. A non-regenerative relay mode includes a smart IAB node acting through a repeater, in which a signal is not decoded before amplification for latency reduction. Delay-sensitive data refers to a broad category of data traffic that requires very low end to end delay budget which must avoid sources of latency as much as possible. An ultra-reliable low latency communication signal (URLLC) is a signal configured to provide ultra-high network reliability of more than 99.999% and very low latency (of 1 millisecond) for packet transmission.

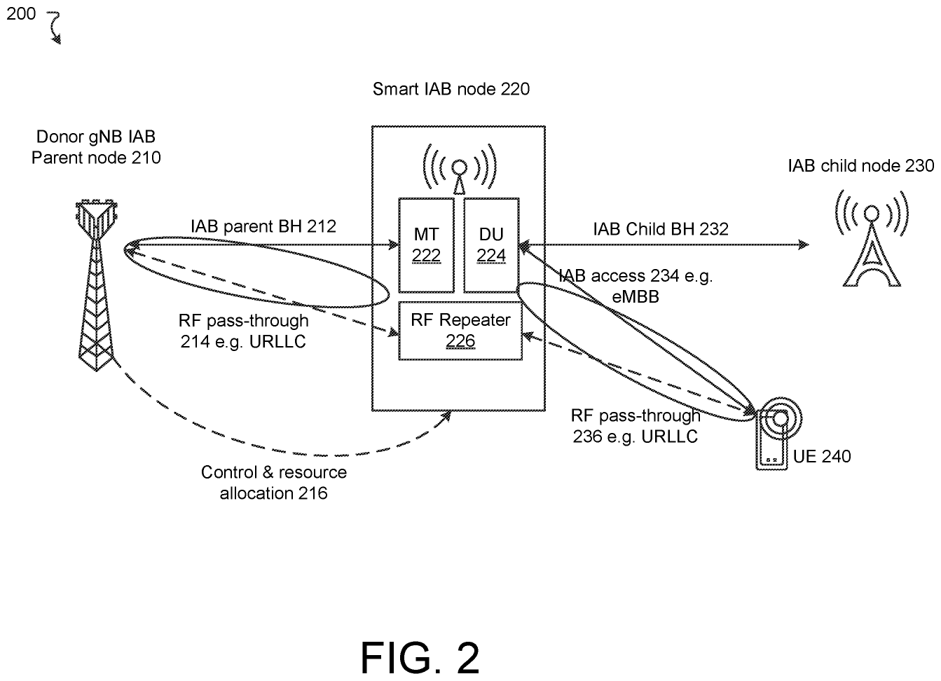

FIG. 2 is a diagram illustrating an arrangement 200 including a smart IAB node 220 that supports a repeater mode, connected to a donor node 210 via a parent backhaul (BH) 212, and a child node 230 via a child BH 232. As shown in FIG. 2, the smart IAB node 220 includes a RF repeater 226 entity in addition to the existing MT (Mobile Terminal) 222 and the DU (Distributed Unit) 224 entities. This arrangement enables the smart IAB 220 to function both as a traditional IAB device (regenerative relay) and as a repeater device (non-regenerative). User traffic of certain classifications, e.g. time or latency sensitive data, such as URLLC/eURLLC 214 and 236 to the donor node 210 and a UE 240, respectively, can pass through the Smart IAB 220 in the repeater mode with minimal latency. In the meantime, user traffic of some other classifications, such as regular eMBB traffic 234, can still go through the existing IAB mode operation.

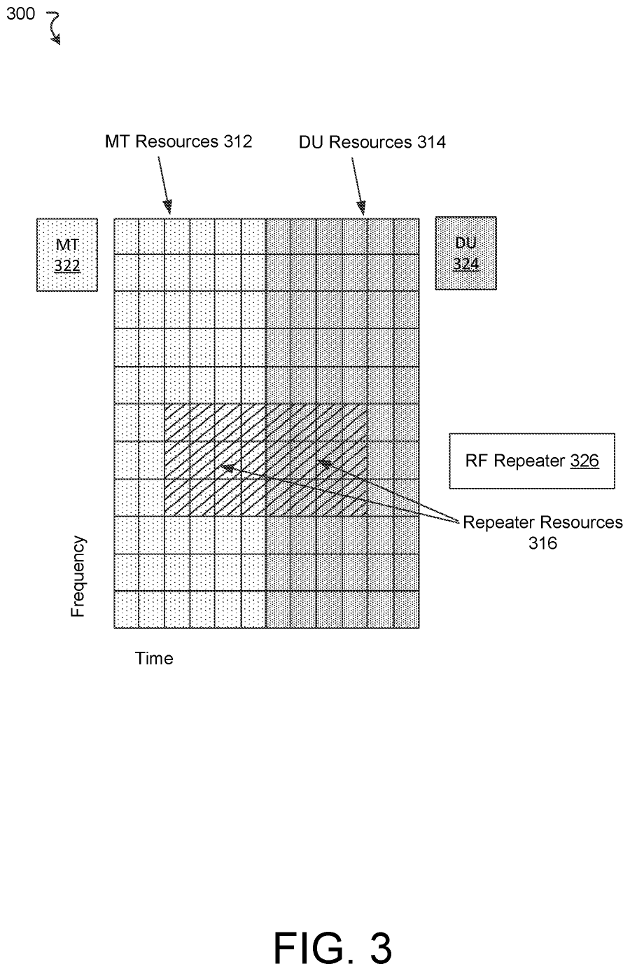

FIG. 3 is a diagram illustrating a division of time-frequency resources between a MT 322, a DU 324, and a RF repeater 326 of a smart IAB node 300. In some implementations, the time-frequency resources be split between the MT. DU and the RF Repeater. FIG. 3 illustrates such a division as an example from a high level. In FIG. 3, the resources 312 are used by the MT for the backhaul link, the resources 314 are used by the DU for the access link, and the resources 316 are used by the RF Repeater for backhaul and access link simultaneously. Note that in Rel16, MT and DU use is signalled explicitly for each symbol as shown in FIG. 3. In Rel17, the MT and DU slots can be scheduled in the same time slot but with different spatial directions (SDM) or frequency allocations (FDM). While SDM and FDM are not prohibited in Rel-16, additional signalling has been included in Rel-17 to assist in resource coordination between parent and child links. Included in this is sub-band H/S/NA resource designation which indicates to the IAB node whether the given time-frequency resources are allocated for the IAB-DU (H), the IAB-MT (NA), or to be more flexibly controlled by the parent node(S) through dynamic indication or implicit determination. In each scenario separate resource designation for an in-band repeater is not supported.

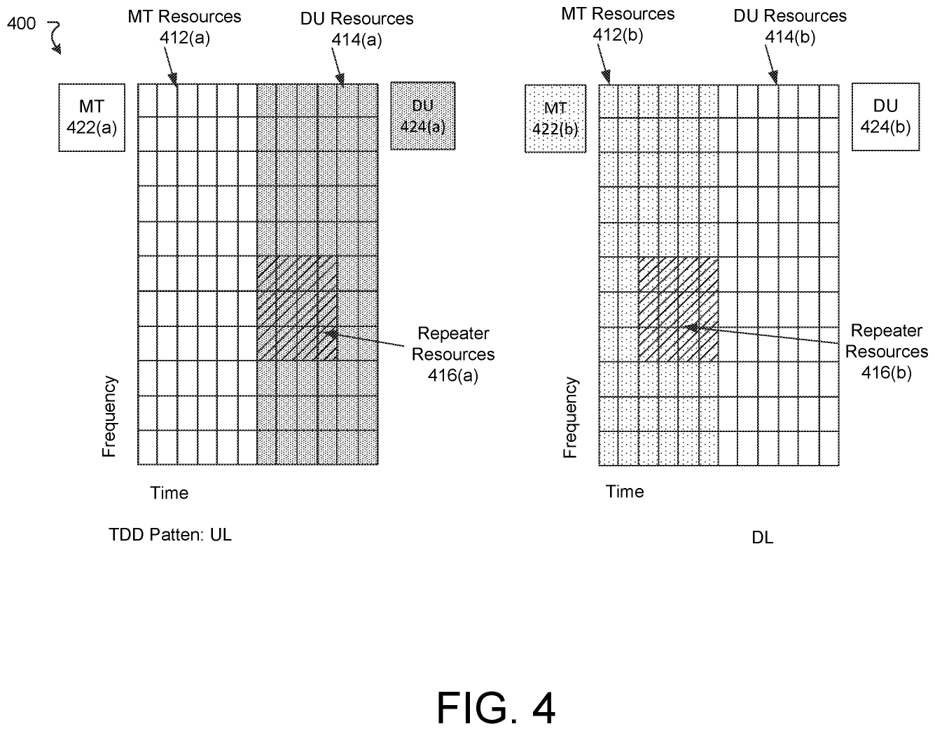

FIG. 4 is a diagram illustrating time-division duplex constraints 400 on repeating resources in non-full duplex and non-independent spatial division multiplex IAB nodes in UL and DL scenarios. Each scenario has respective MTs 422 (a), 422 (b), DUs 424 (a), 424 (b), and repeaters 426 (a), 426 (b) with MT resources 412 (a), 412 (b), DU resources 414 (a), 414 (b), and repeater resources 416 (a), 416 (b).

In repeating IAB nodes that do not support full duplex operation, in some implementations one may adapt the repeating time-frequency resources 416 (a) and 416 (b) to the TDD or SDM pattern of the IAB transmissions. For example, in TDD constrained IAB (white-colored time-frequency resources in FIG. 4 represent unused resources). In some implementations, the time-frequency resources reserved for the repeater entity can be persistent (always on), semi-persistent, or dynamically assigned according to the amount of time/delay sensitive data traffic that needs to be repeated.

When the resource grid for IAB mode and resource grid for repeating mode are simultaneously used, one may ensure that they do not interfere with each other, resulting in decreased quality for both transmissions.

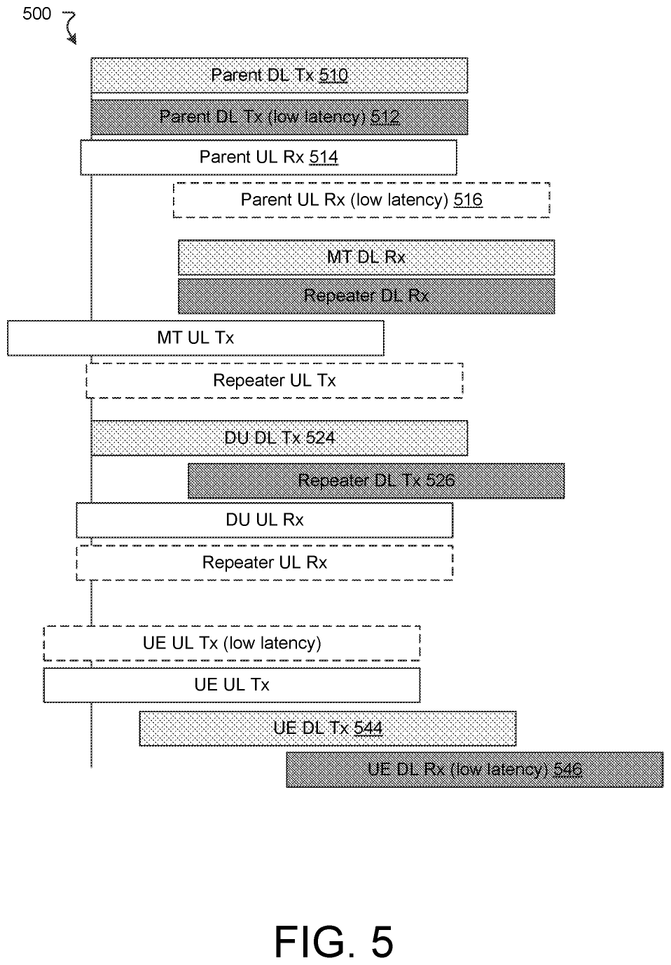

FIG. 5 is a timing diagram illustrating a one-hop transmission 500 with both IAB and repeater operation. As shown in FIG. 5, a DL transmission originating at a parent node multiplexes conventional IAB traffic 510—with low-latency (LL) traffic 512 for transmission. While signals 510, 512 may be transmitted synchronously from the parent, unless buffering is employed to delay repeater transmission by one slot (which would result in a significant increase in latency), the LL transmission by the repeater 526 may be transmitted to the UE at a timing offset from the IAB slot timing represented by 524. This offset will be a function of the propagation delay determined by link distance, and so may not be easily calibrated. The result of this offset may be a disruption of a phase coherence of the OFDM signal which can produce inter-carrier interference (ICI).

This ICI can be mitigated by a guard band which must be configured at the IAB depending on relevant link conditions and relative power levels between the IAB transmissions on the repeater transmissions. Additionally, if the propagation delay is significant enough, additional collisions with consecutive slots can occur which may or may not have a similar resource allocation. Mitigating inter-symbol interference (ISI) due to this propagation delay may require configuring guard symbols at time boundaries between a regenerative and a non-regenerative transmission. The required number of symbols will again be determined by the relative link distances and processing latency of the amplify and forward operation, and so may be required to be updated on a semi-static or dynamic basis.

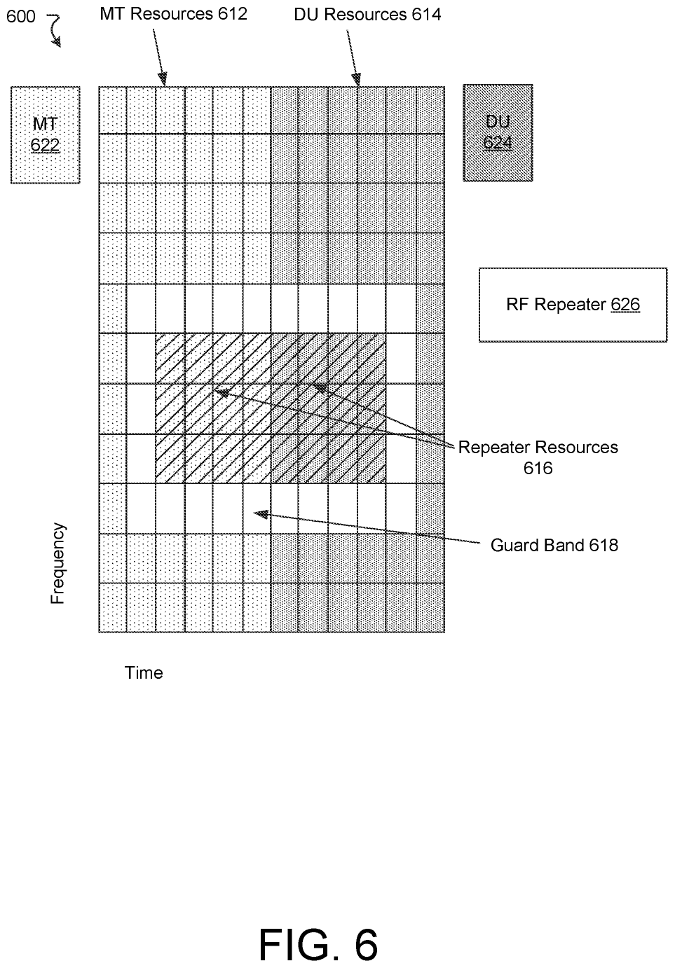

An example solution of achieving channel separation between the repeating resource grid and the IAB resource grid through the use of guard band is shown in FIG. 6. FIG. 6 is a diagram illustrating a repeating resource grid 600 with MT 622 with resources 612, DU 624 with resources 614, and repeater 626 with resources 616. As shown in FIG. 6, the repeater resources 616 are surrounded by a guard band 618 of resource elements.

A solution which may be used alternatively or in addition in some implementations is to ensure alignment between the repeating resource grid and the IAB resource grid by way of timing manipulation and/or predistortion.
In the downlink direction, as shown in FIG. 5, at the UE Rx antenna, the repeater traffic 546 may arrive later than the IAB traffic 544 due to (1) distance between the repeater and the IAB node (2) repeater internal delay. In order to make IAB and repeater traffic arrive at the UE at the same time (i.e., aligned), these time differences may be compensated.
   a. The time difference between the IAB node and the donor can be calculated by the donor if the IAB-MT informs the donor of the timing advance the donor used relative to the detected downlink frame boundary. The internal repeater delay is known to the donor during capability signalling.
   b. In some implementations, the IAB-DU sends downlink control information (DCI) in the IAB mode to the UE. Included in the DCI, a PDSCH resource assignment indicates a PDSCH symbol is located in the repeating resources with starting symbol of N. The donor-DU, in contrast, will send out PDSCH K symbols ahead of symbol N. The duration of K symbols may compensate the distance between the donor and the repeating IAB, the internal repeater delay, plus a time correction factor (to round up to the symbol boundary). This time correction factor may be achieved at the donor gNB by applying a timing offset (pre-distortion) to the repeater resource grid before sending the repeater traffic out along with the IAB traffic. In this way, the PDSCH sent by the gNB DU may align correctly at symbol boundary with other PDSCH sent by the IAB-DU.
   c. The UE may correctly detect the DCI and subsequently demodulate the PDSCH at symbol N as indicated in DCI. In other words, this operation is transparent to the UE.
   d. The DCI may be sent in an earlier slot (k0>0) than the slot for the repeating mode PDSCH. The DCI can be semi-static.
Likewise, in the uplink direction, as shown in FIG. 5, a similar problem may occur. The UL problem may be mitigated through configuration of a special timing advance (TA) or alternative timing loop for transmissions that multiplex both IAB and repeater transmissions such that they arrive at the donor gNB at the same time.

In some implementations, the improved technique provides signalling to enable signal repetition in a smart IAB node. As is shown in FIG. 2, the donor node 210 has a control & resource allocation channel 216 that manages the smart IAB node 220 and determines if certain data traffic goes through repeater mode or IAB mode. In some implementations, the determination is based on whether or not traffic is delay sensitive, with delay sensitive traffic passing through the repeated time frequency resources.

In some implementations, the donor node 210 makes complex determinations involving a scheduler operation and beam management constraints/knowledge at the donor node 210. In some implementations, the gNB decides whether the repeater is to use the same beams as the IAB nodes or if the repeating IAB node is not to use beamforming (assuming the repeating IAB node supports this behaviour, which is expected in case the repeating operation is implemented using a separate panel). In some implementations, the scheduled/required TPUT on “repeated” and “IAB” resources is taken into account to optimize latency (e.g., if segmentation is necessary due to limited TB size.

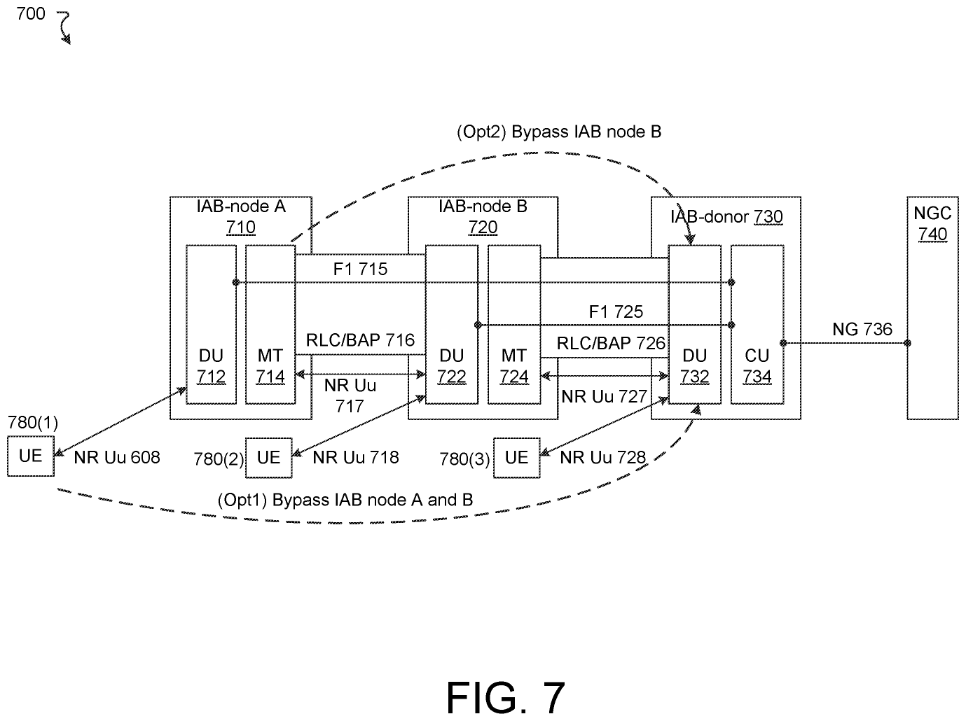

The improved technique, in some implementations, involves consideration of two options of RF repetition in a multi-hop smart repeaters. FIG. 7 is a diagram illustrating a scenario 700 showing the two options for using an RF repeat mode in a two-hop smart IAB network to bypass certain nodes in a backhaul adaptation protocol. FIG. 7 depicts two-hop smart IAB node 710, 720 deployment with the donor node 730. There are 3 UEs 780 (1,2,3) in their respective coverage area connected via respective NR Uu connections 708, 718, and 728. There are also NR Uu connections 717, 727 between MT 714 and DU 722, and MT 724 and DU 732, respectively. The smart IAB node 710 has a DU 712 and MT 714, the smart IAB node 720 has a DU 722 and MT 724, and the donor node 730 has a DU 732 and CU 734. The donor node 730 is connected to a NR core 740 via a NG connection 736. There are F1 connections 715 and 725 between, respectively, DU 712 and CU 734, and DU 722 and MT 734.

BAP from BAP/RLC 716, 726 is a “Backhaul Adaptation Protocol.” BAP may be understood as a tunnelling protocol introduced in Rel-16 IAB to split, unify, and route traffic from different UEs over one or more IAB-nodes.

The two options are as follows.
(Opt1) Repeater mode between the UE and the (last) IAB-donor node. (This tends to have a lower delay but higher block error rate (BLER).)
   To establish multiple hop IAB bypass to connect the UE with the CU directly.
   To set up the RLC as if it is local to the last donor DU.
   DU will have direct F1 link to the repeater traffic.
   Donor to create HARQ, Beam management and the RLF entities for the UE.
(Opt2) Repeater mode between IAB nodes. (This tends to have higher delay but lower BLER.)
   To establish connection point to bypass one or more IAB nodes (e.g., in a multi-hop scenario) and be still understood by the next IAB hop.
   To add the correct BAP header (for the final hop, not the current hop).
   Notify the sending IAB nodes of the intended BAP ID after repeating.

The decision of whether to use the dynamic architecture options 1 or 2 is based on a maximum allowed delay. In some implementations since option 1 is increasing the BLER (i.e., reduces throughput and reliability), option 2 is preferred whenever possible.

It is noted that “bypass” in FIG. 7 does not imply the signals are not amplified at each of the bypassed repeating IAB nodes. Rather, it means that the pure IAB part of the IAB-node is bypassed, and no BAP operation/buffering is needed.

Both options are transparent to the UE. The UE is transmitting its QoS identified DRBs on the gNB scheduled resources, without knowledge of those resources being special or not.

As discussed above, use of an amplify and forward repeater has the problem of amplifying noise and radio impairments and so is expected to have worse link quality in comparison to IAB. In scenarios where link quality is poor enough this can also result in increases in latency since conservative coding and/or repetition will result in reduced capacity which can limit TB size resulting in excessive RLC segmentation. Because both repeater and IAB entities share hardware, regulatory limits on transmitted power will require that both the repeater and IAB transmissions share the limited power available when making transmissions. This can further limit capacity by reducing link quality. Operator flexibility can be improved by enabling a device to configure the relative power of IAB transmissions to LL transmissions.

To address this issue in deployment scenarios where link quality for the repeater is limiting throughput, configuring devices to allocate more power to LL transmissions (relative to IAB transmissions) can help avoid bottlenecks.

In some implementations, a smart IAB sends a message to the parent node (an IAB node or a donor gNB) to indicate the support of the repeater mode. In some implementations, the capability signalling may comprise the following parameters:
IAB_ID
   Identification of the Smart IAB
Iab-repeatingSupport-r18 ENUMERATED {true}
   indicates if this IAB supports repeater mode
Iab-panelType-r18 ENUMERATED {n1 n2}
   indicates if the IAB has SinglePanel or MultiPanel (2 in this example}
Iab_repeatingResources-r18
   FrequencyDomainAllocation INTEGER (0 . . . 273)
   TimeDomainAllocation INTEGER (sym0 . . . sym13)
   GuardbandResource INTEGER (n1,n2)
      Indicates to the DU in the parent node the max size of the resources available for the repeater mode.
Iab_repeatingDelay-r18
   indicates the internal delay of the repeater for resource alignment purpose.

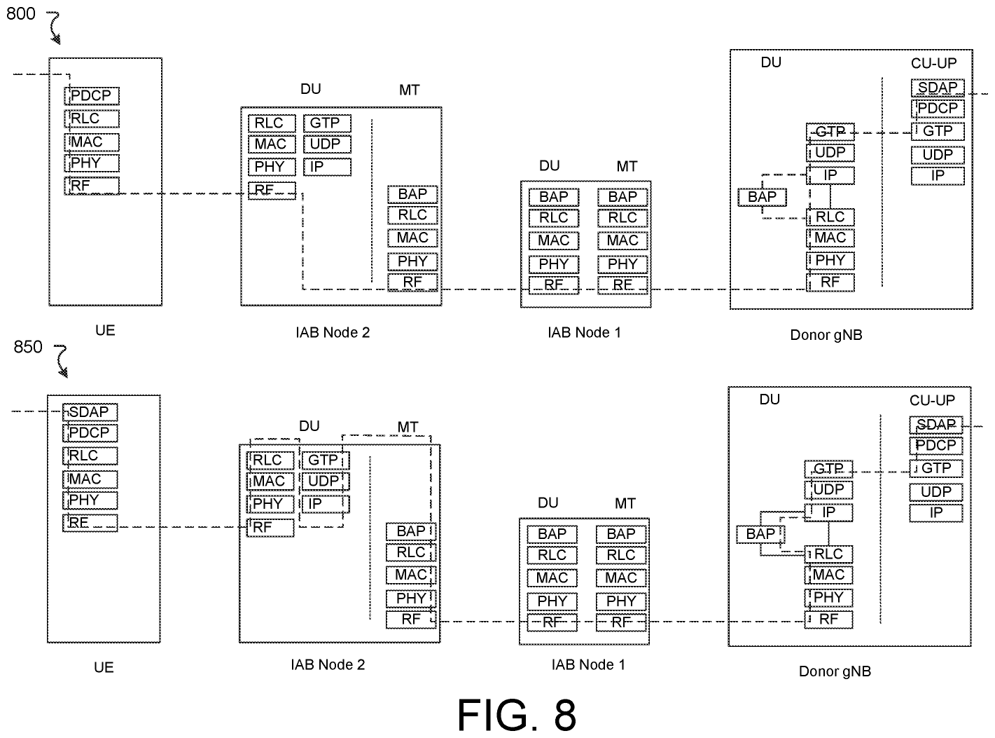

FIG. 8 is a diagram illustrating a user plane protocol stack architectures 800, 850 for the two options Opt1, Opt2 described above, respectively. FIG. 8 illustrates the User Plane Protocol Stack of the two scenarios in FIG. 6 when (Opt1) all IAB nodes use repeater mode and the UE communicates with the donor node directly and (Opt2) one of the IAB node uses repeater mode. The repeater mode is shown as direct connection between the RF layer and RF layer of the receive and transmit entities. The dashed lines show how the user plane data (e.g. delay sensitive data) flows through the protocol stack.

When the smart IAB is in the repeater mode, the BAP protocol layer is bypassed. The donor gNB is responsible for establishing the repeater mode and ensuring the continuity in the protocol stack. More specifically, in Opt1, the donor DU shall provide local RLC stack (bypass the BAP) to recover the user plane data; in Opt2, the donor DU shall configure the correct BAP parameters such that after the bypass, the next hop IAB nodes can still route the traffic correctly.

SDAP protocol is responsible for mapping between a QoS flow and a DRB for both DL and UL. It also marks the QoS flow ID (QFI) in both DL and UL packets where the donor DU can decide if repeater mode is required.

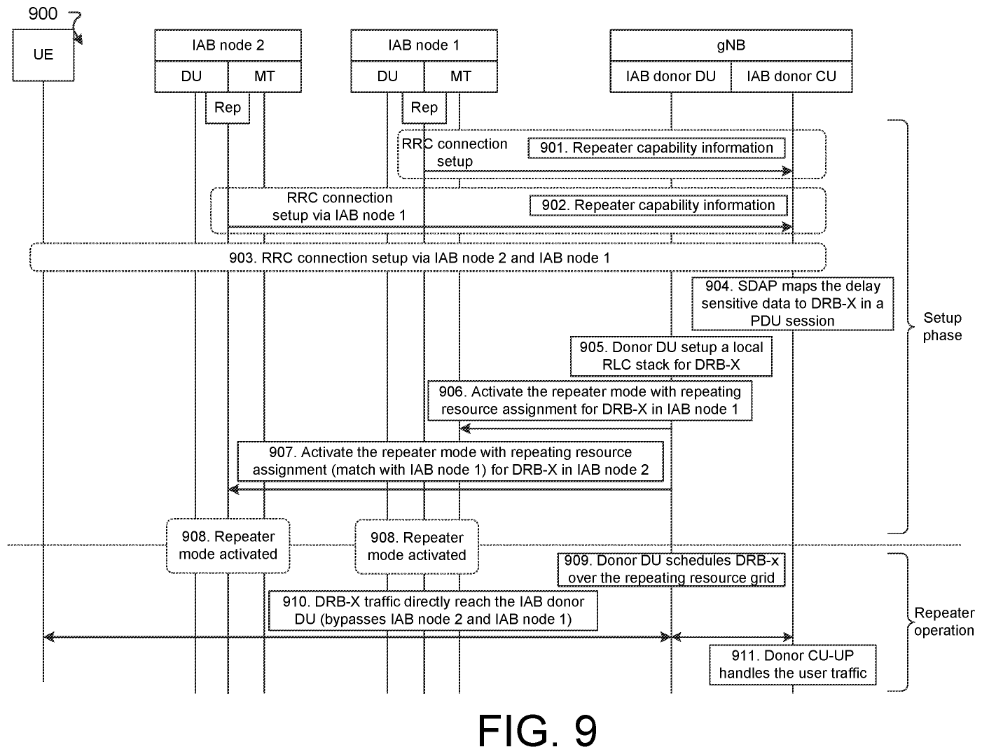

FIG. 9 is a sequence diagram illustrating a signalling flow 900 to bypass both IAB nodes 1 and 2.

At 901 and 902, the IAB nodes inform the donor node of its repeating capability through RRC connection setup messages.

At 903, a UE attaches to the network via a RRC connection setup. message. When the UE is attached to the network, the 5G core inserts QFI (QOS Flow Identifier) to a plurality of IP traffic flows, which in turn maps to different Data Radio Bearers by the donor CU-UP (user-plane).

At 904, the donor CU-UP maps, via a SDAP layer, the delay sensitive data to data radio bearers in a PDU session (DRB-X).

At 905, the donor DU sets up a local RLC stack for the DRB-X.

At 906 and 907, for URLLC traffic, the donor informs the IAB nodes to activate the repeating resource grids for the corresponding URLLC DRB, i.e., DRB-X.

At 908, the IAB nodes activate their repeater modes.

At 909, the donor DU maps the URLLC DRB at the repeating resource grid.

At 910, the URLLC traffic flows directly between the donor and the UE, bypassing both IAB nodes.

At 911, the donor CU-CP handles the user traffic.

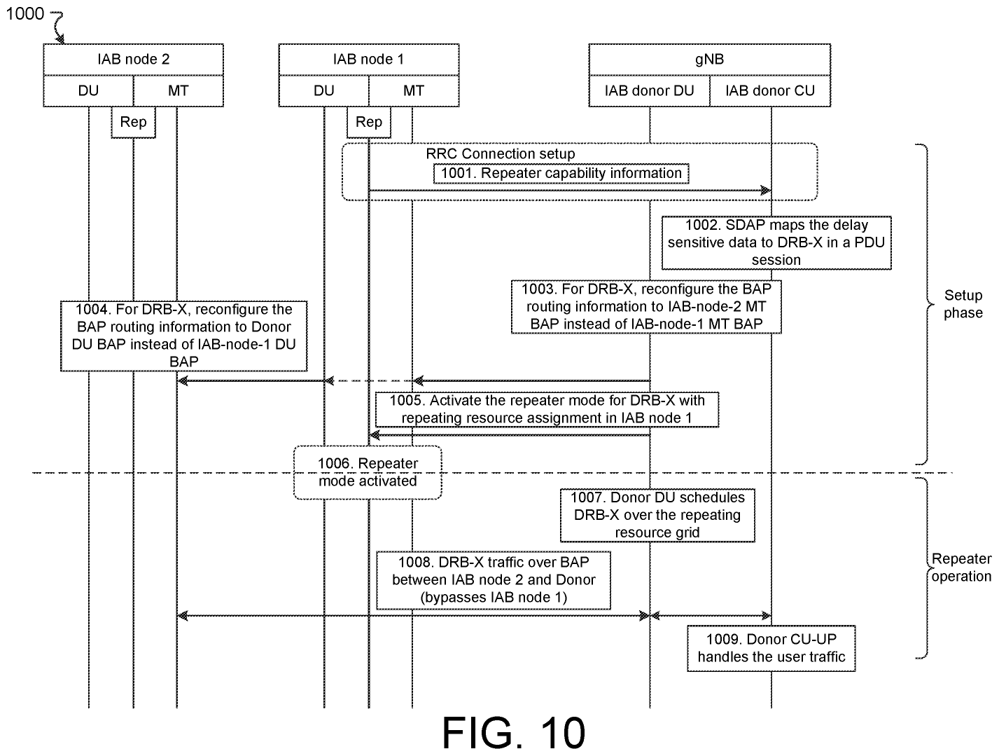

FIG. 10 is a sequence diagram illustrating a signaling flow 1000 to bypass IAB node 1 only.

At 1001, the IAB node 1 informs the donor node of its repeating capability through a RRC connection setup message.

At 1002, the donor CU-UP maps, via a SDAP layer, the delay sensitive data to data radio bearers in a PDU session (DRB-X).

At 1003, the donor DU reconfigures BAP routing information to IAB node 2 MT BAP instead of IAB node 1 MT BAP.

At 1004, the IAB node 2, for DRB-X, reconfigures the BAP routing information to the donor DU BAP instead of IAB node 1 DU BAP.

At 1005, for URLLC traffic, the donor informs the IAB node 1 to activate the repeating resource grids for the corresponding URLLC DRB, i.e., DRB-X.

At 1006, the IAB node 1 activates its repeater mode.

At 1007, the donor DU maps the URLLC DRB at the repeating resource grid.

At 1008, the URLLC traffic flows between the IAB node 2 and the donor node, bypassing IAB node 1.

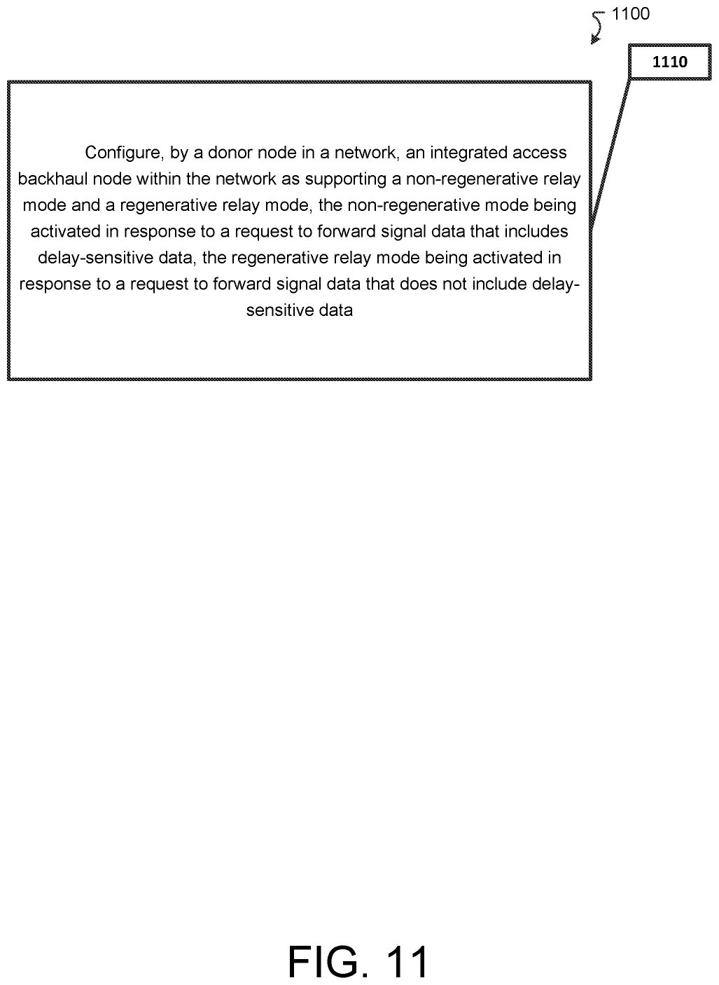

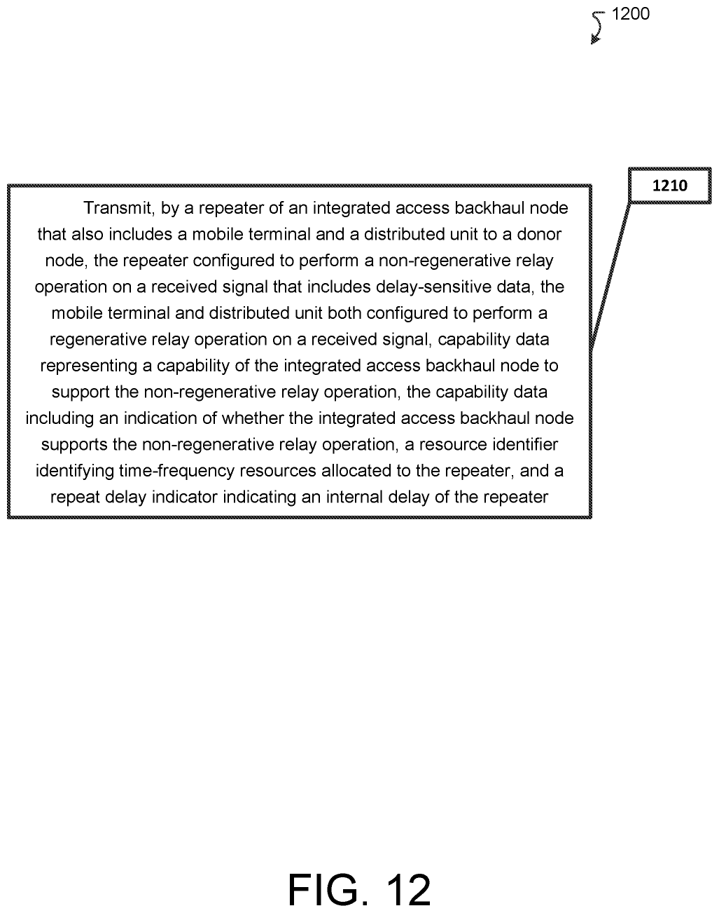

At 1009, the donor CU-CP handles the user traffic.
Example 1-1: FIG. 11 is a flow chart illustrating a process 1100 of relaying signals via a smart IAB node. Operation 1110 includes configuring, by a donor node in a network, an integrated access backhaul node within the network as supporting a non-regenerative relay mode and a regenerative relay mode, the non-regenerative mode being activated in response to a request to forward signal data that includes delay-sensitive data, the regenerative relay mode being activated in response to a request to forward signal data that does not include delay-sensitive data.
Example 1-2: According to an example implementation of example 1-1, wherein the delay sensitive data is included in an ultra-reliable low latency communication signal.
Example 1-3: According to an example implementation of examples 1-1 or 1-2, wherein the integrated access backhaul node includes (i) a repeater configured to perform a non-regenerative relay operation on a received signal that includes delay-sensitive data and (ii) a mobile terminal and distributed unit both configured to perform a regenerative relay operation on a received signal.
Example 1-4: According to an example implementation of example 1-3, wherein the integrated access backhaul node has time-frequency resources, wherein the mobile terminal is configured to use a first set of the time-frequency resources for a backhaul link and the distributed unit is configured to use a second set of the time-frequency resources for an access link, and wherein the method further comprises allocating a subset of the first set and the second set of time-frequency resources for use by the repeater.
Example 1-5: According to an example implementation of example 1-4, wherein the subset of the first set and the second set of time-frequency resources for use by the repeater is allocated persistently.
Example 1-6: According to an example implementation of examples 1-4 or 1-5, wherein the subset of the first set and the second set of time-frequency resources for use by the repeater is allocated semi-persistently.
Example 1-7: According to an example implementation of examples 1-4 to 1-6, wherein the subset of the first set and the second set of time-frequency resources for use by the repeater is allocated dynamically according to an amount of delay-sensitive data on which the regenerative relay operation the repeater is expected to perform.
Example 1-8: According to an example implementation of example 1-7, wherein the method further comprises allocating a second subset of the first set and the second set of time-frequency resources to a guard band that is unused, the guard band mitigating inter-carrier interference at the integrated access backhaul node.
Example 1-9: According to an example implementation of examples 1-7 or 1-8, wherein the method further comprises configuring guard symbols within the first set and the second set of time-frequency resources between time resources allocated for the regenerative relay operation and time resources allocated for the non-regenerative relay.
Example 1-10: According to an example implementation of examples 1-4 to 1-9, wherein the method further comprises receiving, from the mobile terminal of the integrated access backhaul node, timing advance data representing a timing advanced used to compensate for time differences between signals carrying delay-sensitive data and signals not carrying delay-sensitive data, and generating a timing difference between the integrated access backhaul node and the donor node based on the timing advance.
Example 1-11: According to an example implementation of examples 1˜4 to 1-10, wherein the method further comprises receiving, from the integrated access backhaul node, capability data representing a capability of the integrated access backhaul node to support the non-regenerative relay mode, the capability data including an indication of whether the integrated access backhaul node supports the non-regenerative relay mode, a resource identifier identifying the time-frequency resources allocated to the repeater, and a repeat delay indicator indicating an internal delay of the repeater.
Example 1-12: According to an example implementation of example 1-11, wherein the method further comprises determining, based on the capability data, whether the repeater of the integrated access backhaul node will use the same beams as or corresponding beams to the mobile terminal and distributed unit of the integrated access backhaul node.
Example 1-13: According to an example implementation of examples 1-11 or 1-12, wherein the donor node has a distributed unit and a central unit, and wherein the method further comprises determining an amount of delay-sensitive data to send to the repeater of the integrated access backhaul node based on the repeat delay indicator.
Example 1-14: According to an example implementation of examples 1-4 to 1-13, wherein the donor node has a distributed unit and a central unit, and wherein the method further comprises configuring, by the distributed unit of the donor node, a local radio link control stack for a data radio bearer configured to carry delay-sensitive data, transmitting, by the distributed unit of the donor node, repeater activation data to the repeater of the integrated access backhaul node to activate the subset of the first set and the second set of time-frequency resources, and receiving, directly from a user equipment in the network and bypassing the integrated access backhaul node, delay-sensitive data via the data radio bearer.
Example 1-15: According to an example implementation of examples 1-4 to 1-14, wherein the donor node has a distributed unit and a central unit, wherein the integrated access backhaul node is a first integrated access backhaul node, wherein a second integrated access backhaul node is in the network, the second integrated access backhaul node including a repeater and a mobile terminal, and wherein the method further comprises configuring backhaul access protocol routing information to the mobile terminal of the second integrated access backhaul node for a data radio bearer configured to carry delay-sensitive, transmitting, by the distributed unit of the donor node, repeater activation data to the repeater of the first integrated access backhaul node to activate the subset of the first set and the second set of time-frequency resources of the first integrated access backhaul node, and receiving, from a user equipment in the network via the first integrated access backhaul node, delay-sensitive data via the data radio bearer.
Example 1-16: According to an example implementation of examples 1-4 to 1-15, wherein configuring the integrated access backhaul node within the network as supporting a non-regenerative relay mode and a regenerative relay mode includes transmitting power control data indicating a power of signals transmitted from the mobile terminal and distributed unit relative to the power of signals transmitted from the repeater.
Example 1-17: An apparatus comprising means for performing a method of any of examples 1-1 to 1-16.
Example 1-18: A computer program product including a non-transitory computer-readable storage medium and storing executable code that, when executed by at least one data processing apparatus, is configured to cause the at least one data processing apparatus to perform a method of any of examples 1-1 to 1-16.
Example 2-1: FIG. 12 is a flow chart illustrating a process 1200 of relaying signals via a smart IAB node. Operation 1210 includes transmitting, by a repeater of an integrated access backhaul node that also includes a mobile terminal and a distributed unit to a donor node, the repeater configured to perform a non-regenerative relay operation on a received signal that includes delay-sensitive data, the mobile terminal and distributed unit both configured to perform a regenerative relay operation on a received signal, capability data representing a capability of the integrated access backhaul node to support the non-regenerative relay operation, the capability data including an indication of whether the integrated access backhaul node supports the non-regenerative relay operation, a resource identifier identifying time-frequency resources allocated to the repeater, and a repeat delay indicator indicating an internal delay of the repeater.
Example 2-2: According to an example implementation of example 2-1, wherein configuring the integrated access backhaul node within the network as supporting a non-regenerative relay mode and a regenerative relay mode includes receiving, from the donor node, power control data indicating a power of signals transmitted from the mobile terminal and distributed unit relative to the power of signals transmitted from the repeater.
Example 2-3: According to an example implementation of examples 2-1 or 2-2, wherein the method further comprises transmitting, to the donor node, control information to be used in a configuration of the integrated access backhaul node, and receiving, from the donor node, configuration information for configuring the repeater and the mobile terminal and distributed unit.
Example 2-4: According to an example implementation of example 2-3, wherein the control information includes at least one of timing alignment information, channel quality estimates, power control assist information, or beam measurement information.
Example 2-5: An apparatus comprising means for performing a method of any of examples 2-1 to 2-4.
Example 2-6: A computer program product including a non-transitory computer-readable storage medium and storing executable code that, when executed by at least one data processing apparatus, is configured to cause the at least one data processing apparatus to perform a method of any of examples 2-1 to 2-4.

### List of Example Abbreviations

CN (5G) Core Network
LL Low Latency
CU Central Unit
TPUT Throughput NG-RAN Next-generation radio access network
UE User Equipment
SDAP Service Data Adaptation Protocol
BAP Backhaul Adaptation Protocol
BLER Block Error Rate

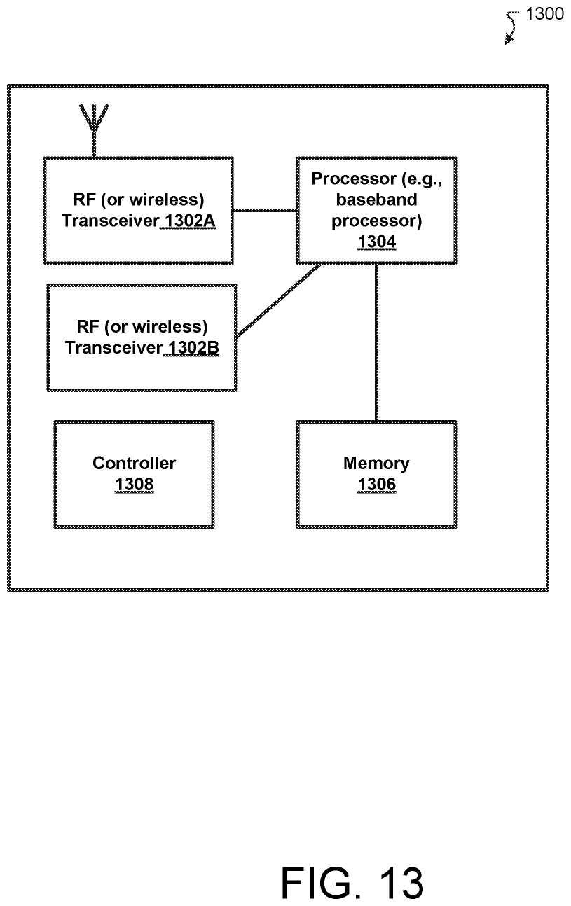

FIG. 13 is a block diagram of a wireless station (e.g., AP, BS, e/gNB, NB-IoT UE, UE or user device) 1300 according to an example implementation. The wireless station 1300 may include, for example, one or multiple RF (radio frequency) or wireless transceivers 1302A, 1302B, where each wireless transceiver includes a transmitter to transmit signals (or data) and a receiver to receive signals (or data). The wireless station also includes a processor or control unit/entity (controller) 1304 to execute instructions or software and control transmission and receptions of signals, and a memory 1306 to store data and/or instructions.

Processor 1304 may also make decisions or determinations, generate slots, subframes, packets or messages for transmission, decode received slots, subframes, packets or messages for further processing, and other tasks or functions described herein. Processor 1304, which may be a baseband processor, for example, may generate messages, packets, frames or other signals for transmission via wireless transceiver 1302 (1302A or 1302B). Processor 1304 may control transmission of signals or messages over a wireless network, and may control the reception of signals or messages, etc., via a wireless network (e.g., after being down-converted by wireless transceiver 1302, for example). Processor 1304 may be programmable and capable of executing software or other instructions stored in memory or on other computer media to perform the various tasks and functions described above, such as one or more of the tasks or methods described above. Processor 1304 may be (or may include), for example, hardware, programmable logic, a programmable processor that executes software or firmware, and/or any combination of these. Using other terminology, processor 1304 and transceiver 1302 together may be considered as a wireless transmitter/receiver system, for example.

In addition, referring to FIG. 13, a controller (or processor) 1308 may execute software and instructions, and may provide overall control for the station 1300, and may provide control for other systems not shown in FIG. 13 such as controlling input/output devices (e.g., display, keypad), and/or may execute software for one or more applications that may be provided on wireless station 1300, such as, for example, an email program, audio/video applications, a word processor, a Voice over IP application, or other application or software.

In addition, a storage medium may be provided that includes stored instructions, which when executed by a controller or processor may result in the processor 1304, or other controller or processor, performing one or more of the functions or tasks described above.

According to another example implementation, RF or wireless transceiver(s) 1302A/1302B may receive signals or data and/or transmit or send signals or data. Processor 1304 (and possibly transceivers 1302A/1302B) may control the RF or wireless transceiver 1302A or 1302B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G uses multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall as intended in the various embodiments.

1.-24. (canceled)

25. An apparatus, comprising:
at least one processor; and
at least one memory including computer program code;
the at least one memory and the computer program code configured to cause the apparatus at least to:
configure, by a donor node in a network, an integrated access backhaul node within the network as supporting a non-regenerative relay mode and a regenerative relay mode, the non-regenerative mode being activated in response to a request to forward signal data that includes delay-sensitive data, the regenerative relay mode being activated in response to a request to forward signal data that does not include delay-sensitive data.

26. The apparatus as in claim 25, wherein the delay sensitive data is included in an ultra-reliable low latency communication signal.

27. The apparatus as in claim 25, wherein the integrated access backhaul node includes (i) a repeater configured to perform a non-regenerative relay operation on a received signal that includes delay-sensitive data and (ii) a mobile terminal and distributed unit both configured to perform a regenerative relay operation on a received signal.

28. The apparatus as in claim 27, wherein the integrated access backhaul node has time-frequency resources,
wherein the mobile terminal is configured to use a first set of the time-frequency resources for a backhaul link and the distributed unit is configured to use a second set of the time-frequency resources for an access link, and
wherein the at least one memory and the computer program code configured to cause the apparatus at least to configure the integrated access backhaul node within the network are further configured to cause the apparatus at least to:
allocate a subset of the first set and the second set of time-frequency resources for use by the repeater.

29. The apparatus as in claim 28, wherein the subset of the first set and the second set of time-frequency resources for use by the repeater is allocated persistently.

30. The apparatus as in claim 28, wherein the subset of the first set and the second set of time-frequency resources for use by the repeater is allocated semi-persistently.

31. The apparatus as in claim 28, wherein the subset of the first set and the second set of time-frequency resources for use by the repeater is allocated dynamically according to an amount of delay-sensitive data on which the regenerative relay operation the repeater is expected to perform.

32. The apparatus as in claim 31, wherein the at least one memory and the computer program code configured to cause the apparatus at least to allocate the subset of the first set and the second set of time-frequency resources for use by the repeater are further configured to cause the apparatus at least to:
allocate a second subset of the first set and the second set of time-frequency resources to a guard band that is unused, the guard band mitigating inter-carrier interference at the integrated access backhaul node.

33. The apparatus as in claim 31, wherein the at least one memory and the computer program code configured to cause the apparatus at least to allocate the subset of the first set and the second set of time-frequency resources for use by the repeater are further configured to cause the apparatus at least to:
configure guard symbols within the first set and the second set of time-frequency resources between time resources allocated for the regenerative relay operation and time resources allocated for the non-regenerative relay operation.

34. The apparatus as in claim 28, wherein the at least one memory and the computer program code is further configured to cause the apparatus at least to:
receive, from a donor node, timing advance data representing a timing advanced used to compensate for time differences between signals carrying delay-sensitive data and signals not carrying delay-sensitive data; and
generate a timing difference between the integrated access backhaul node and the donor node based on the timing advance.

35. The apparatus as in claim 28, wherein the at least one memory and the computer program code is further configured to cause the apparatus at least to:
receive, from the integrated access backhaul node, capability data representing a capability of the integrated access backhaul node to support the non-regenerative relay mode, the capability data including an indication of whether the integrated access backhaul node supports the non-regenerative relay mode, a resource identifier identifying the time-frequency resources allocated to the repeater, and a repeat delay indicator indicating an internal delay of the repeater.

36. The apparatus as in claim 35, wherein the at least one memory and the computer program code is further configured to cause the apparatus at least to:
determine, based on the capability data, whether the repeater of the integrated access backhaul node will use the same beams as or corresponding beams to the mobile terminal and distributed unit of the integrated access backhaul node.

37. The apparatus as in claim 35, wherein the donor node has a distributed unit and a central unit, and
wherein the at least one memory and the computer program code is further configured to cause the apparatus at least to:
determine an amount of delay-sensitive data to send to the repeater of the integrated access backhaul node based on the repeat delay indicator.

38. The apparatus as in claim 28, wherein the donor node has a distributed unit and a central unit, and
wherein the at least one memory and the computer program code is further configured to cause the apparatus at least to:
configure, by the distributed unit of the donor node, a local radio link control stack for a data radio bearer configured to carry delay-sensitive data;
transmit, by the distributed unit of the donor node, repeater activation data to the repeater of the integrated access backhaul node to activate the subset of the first set and the second set of time-frequency resources; and
receive, directly from a user equipment in the network and bypassing the integrated access backhaul node, delay-sensitive data via the data radio bearer.

39. The apparatus as in claim 28, wherein the donor node has a distributed unit and a central unit,
wherein the integrated access backhaul node is a first integrated access backhaul node,
wherein a second integrated access backhaul node is in the network, the second integrated access backhaul node including a repeater and a mobile terminal, and
wherein the at least one memory and the computer program code is further configured to cause the apparatus at least to:
configure backhaul access protocol routing information to the mobile terminal of the second integrated access backhaul node for a data radio bearer configured to carry delay-sensitive data;
transmit, by the distributed unit of the donor node, repeater activation data to the repeater of the first integrated access backhaul node to activate the subset of the first set and the second set of time-frequency resources of the first integrated access backhaul node; and
receive, from a user equipment in the network via the first integrated access backhaul node, delay-sensitive data via the data radio bearer.

40. The apparatus as in claim 28, wherein the at least one memory and the computer program code configured to cause the apparatus at least to configure the integrated access backhaul node within the network as supporting a non-regenerative relay mode and a regenerative relay mode are further configured to cause the apparatus at least to:
transmit power control data indicating a power of signals transmitted from the mobile terminal and distributed unit relative to the power of signals transmitted from the repeater.

41. An apparatus, comprising:
at least one processor; and
at least one memory including computer program code;
the at least one memory and the computer program code configured to cause the apparatus at least to:
transmit, by a repeater of an integrated access backhaul node that also includes a mobile terminal and a distributed unit to a donor node, the repeater configured to perform a non-regenerative relay operation on a received signal that includes delay-sensitive data, the mobile terminal and distributed unit both configured to perform a regenerative relay operation on a received signal, capability data representing a capability of the integrated access backhaul node to support the non-regenerative relay operation, the capability data including an indication of whether the integrated access backhaul node supports the non-regenerative relay operation, a resource identifier identifying time-frequency resources allocated to the repeater, and a repeat delay indicator indicating an internal delay of the repeater.

42. The apparatus as in claim 41, wherein the at least one memory and the computer program code configured to cause the apparatus at least to configure the integrated access backhaul node within the network as supporting a non-regenerative relay mode and a regenerative relay mode are further configured to cause the apparatus at least to:
receive, from the donor node, power control data indicating a power of signals transmitted from the mobile terminal and distributed unit relative to the power of signals transmitted from the repeater.

43. The apparatus as in claim 41, wherein the at least one memory and the computer program code are further configured to cause the apparatus at least to:
transmit, to the donor node, control information to be used in a configuration of the integrated access backhaul node; and
receive, from the donor node, configuration information for configuring the repeater and the mobile terminal and distributed unit, and wherein,
the control information includes at least one of timing alignment information, channel quality estimates, power control assist information, or beam measurement information.

44. The apparatus as in claim 43, wherein the control information includes at least one of timing alignment information, channel quality estimates, power control assist information, or beam measurement information.
